(19) United States
(12) Patent Application Publication
(10) Pub. No.: US 2018/0370041 A1
(43) Pub. Date: Dec. 27, 2018

(54) SMART ROBOT WITH COMMUNICATION CAPABILITIES

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-SIUNG CHIANG, New Taipei (TW); ZHAOHUI ZHOU, Santa Clara, CA (US); NENG-DE XIANG, Shenzhen (CN); XUE-QIN ZHANG, Shenzhen (CN); CHIEH CHUNG, New Taipei (TW)

(21) Appl. No.: 15/947,926

(22) Filed: Apr. 9, 2018

(30) Foreign Application Priority Data
Jun. 21, 2017 (CN) 201710476761.8

(51) Int. Cl. B25J 13/00; B25J 11/00; B25J 9/00; G10L 17/00; G06K 9/00

(52) U.S. Cl. CPC B25J 13/003; B25J 11/0005; G06K 9/00288; G10L 17/005; B25J 9/0003

(57) ABSTRACT

A smart robot with enhanced communication capabilities includes a camera, a voice collection unit configured to collect verbal commands, and a processor coupled with the camera and the voice collection unit. The smart robot receives user's voice through the voice collection unit, identifies and verifies the user's face image captured by the camera, recognizes voice of such verified user and verbal instructions therefrom, and determines and executes a behavior instruction according to multiple relationship tables, to interact with such user or to cause other objects to function according to the user's command.

### CROSS-REFERENCE TO RELATED APPLICATIONS

This application claims priority to Chinese Patent Application No. 201710476761.8 filed on Jun. 21, 2017, the contents of which are incorporated by reference herein.

### FIELD

The subject matter herein generally relates to a smart robot with communication capabilities.

### BACKGROUND

Currently, interactive robots only has single human-machine conversation or a multi-user video capabilities. Accordingly, there is room for improvement within the art.

### BRIEF DESCRIPTION OF THE DRAWINGS

Implementations of the present disclosure will now be described, by way of only, with reference to the attached figures.

FIG. 1 is a block diagram of one embodiment of a running environment of a smart robot with communication capabilities.

FIG. 2 is a block diagram of one embodiment of the smart robot of FIG. 1.

FIG. 3 is a block diagram of one embodiment of a control system of the smart robot of FIG. 2.

FIG. 4 is a schematic diagram of one embodiment of a first relationship table in the control system of FIG. 3.

FIG. 5 is a schematic diagram of one embodiment of a second relationship table in the control system of FIG. 3.

FIG. 6 is a schematic diagram of one embodiment of a third relationship table in the control system of FIG. 3.

FIG. 7 is a schematic diagram of one embodiment of a fifth relationship table of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

Various embodiments of the present disclosure will be described in relation to the accompanying drawings.

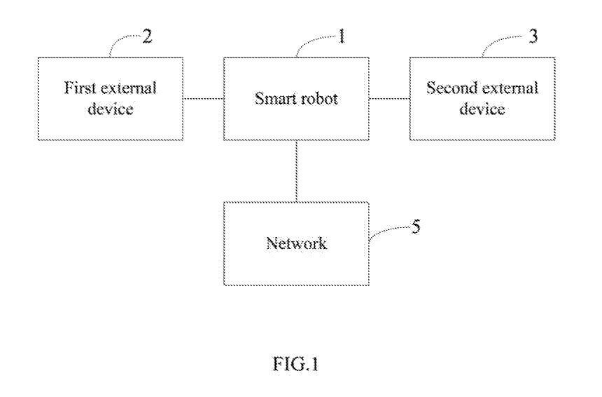

FIG. 1 illustrates a running environment of a smart robot 1 with communication capabilities. The smart robot 1 receives a control signal sent by a first external device 2, allowing the robot 1 to control a second external device 3. In at least one embodiment, the first external device 2 can be a remote control, mobile phone, a tablet computer, or other device that can emit control signals. The second external device 3 can be, for example, a household electrical appliance, such as a television, an air conditioner, an electric lamp, or a microwave oven. In at least one embodiment, the smart robot 1 connects to a network 5. The network 5 can be the Internet. The robot may have simulated eyes, mouth, or other human or animal-like features (none shown in FIGS).

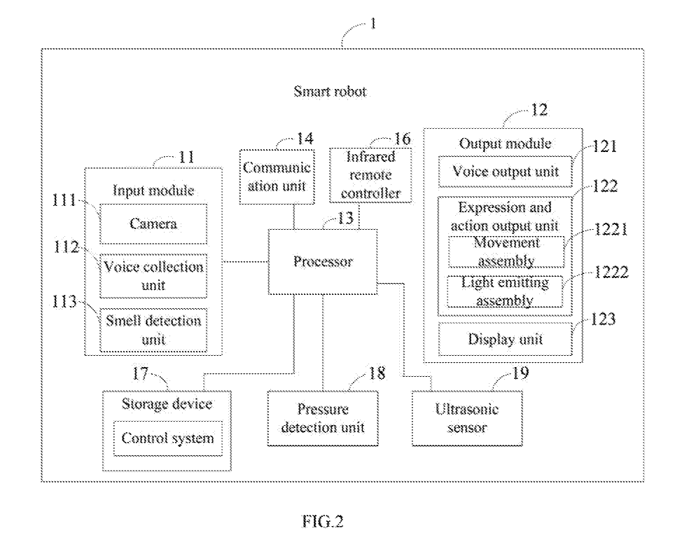

FIG. 2 illustrates a block diagram of one embodiment of the smart robot 1. The smart robot 1 includes, but is not limited to, an input module 11, an output module 12, a processor 13, a communication unit 14, an infrared remote controller 16, a storage device 17, a pressure detection unit 18, and an ultrasonic sensor 19. The input module 11 includes, but is not limited to, a camera 111, a voice collection unit 112, and a smell detection unit 113. The camera 111 captures images of objects around the smart robot 1. The voice collection unit 112 collects verbal commands. In at least one embodiment, the voice collection unit 112 can be a microphone. The smell detection unit 113 detects smells around the smart robot 1. In at least one embodiment, the voice collection unit 112 can be an odor sensor. The output module 12 includes, but is not limited to, a voice output unit 121, an expression and action output unit 122, and a display unit 123. The voice output unit 121 is used to output speech and music. In at least one embodiment, the voice output unit 121 can be a loudspeaker. The expression and action output unit 122 includes a movement assembly 1221 and a light emitting assembly 1222. The movement assembly 1221 includes, but is not limited to, causing the opening and closing of the eyes and/or mouth, and a driving wheel. The light emitting assembly 1222 can be an LED lamp. The display unit 123 is used to display expression images. For example, the expression can be happiness, misery, or other expression of mood. The smart robot 1 communicates with the first external device 2 through the communication unit 14. In at least one embodiment, the communication unit 14 can be a WIFI^{TH} communication module, a ZIGBEE^{TH} communication module, or a BLUETOOTH^{TH} module. The infrared remote controller 16 controls the second external device 3, such as to turn on/off the external device, or to exchange working mode of the second external device 3. The pressure detection unit 18 detects the user's physical pressure on the smart robot 1. In at least one embodiment, the pressure detection unit 18 can be a pressure sensor.

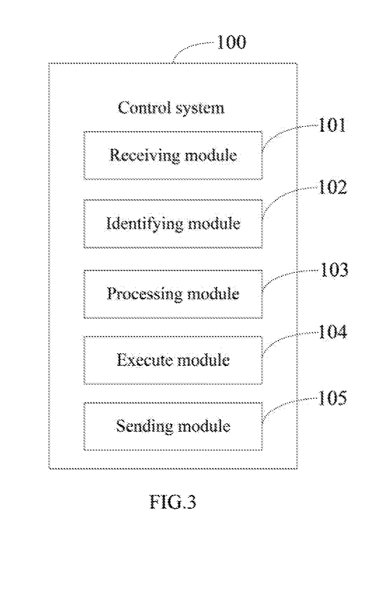

The storage device 17 stores data and programs for controlling the smart robot 1. For example, the storage device 17 can store a control system 100 (referring to FIG. 3), preset face images, and preset voices. In at least one embodiment, the storage device 17 can include various types of non-transitory computer-readable storage mediums. For example, the storage device 17 can be an internal storage system of the smart robot 1, such as a flash memory, a random access memory (RAM) for temporary storage of information, and/or a read-only memory (ROM) for permanent storage of information. The storage device 17 can also be an external storage system, such as a hard disk, a storage card, a data storage medium, or a cloud system accessible by smart robot 1. In at least one embodiment, the processor 13 can be a central processing unit (CPU), a microprocessor, or other data processor chip that performs functions of the control system 100.

FIG. 3 illustrates the control system 100. In at least one embodiment, the control system 100 includes, but is not limited to, a receiving module 101, an identifying module 102, a processing module 103, and an executing module 140. The modules 101-104 of the control system 100 can be collections of software instructions. In at least one embodiment, the software instructions of the receiving module 101, the identifying module 102, the processing module 103, and the executing module 140 are stored in the storage device 17 and executed by the processor 13.

The receiving module 101 receives the user's voice through the voice collection unit 112.

The identifying module 102 compares the user's face image captured by the camera 111 with the preset face images. In at least one embodiment, the preset face image can be preset in the smart robot 1.

When the face image identified by the identifying module 102 matches with the preset face image, the processing module 103 will compare a the user's voice to preset voices and can determine and initiate a behavior instruction according to the identified the user's voice.

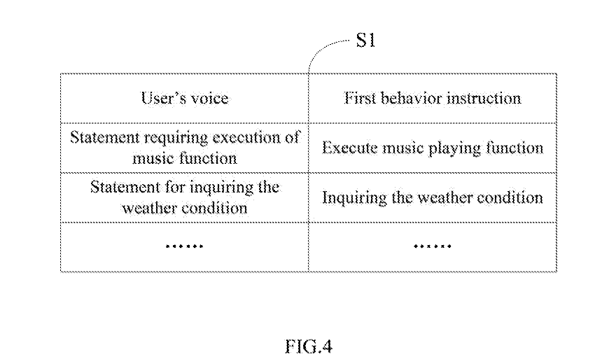

The execute module 104 executes the behavior instruction. In at least one embodiment, the processing module 103 identifies the user's voice and determines through a multi-level relationship table the behavior instruction corresponding to the identified the user's voice. In at least one embodiment, the multi-level relationship table includes a first relationship table S1. FIG. 4 illustrates a schematic diagram of one embodiment of the first relationship table S1. The first relationship table S1 includes a number of the user's voices and a number of first behavior instructions, and defines a relationship between the number of the user's voices and the number of first behavior instructions. In at least one embodiment, the smart robot 1 includes a number of functions, such as music playing function, traffic condition query function, and video playing module. The user's voice can be a statement to cause execution of one of functions of the smart robot 1. The first behavior instruction is a function execution instruction that executes the functions of the smart robot 1. For example, the user's voice in the first relationship table S1 can be a statement requiring execution of music playing function, and the first behavior instruction corresponding to such statement is to execute music playing function. When the processing module 103 identifies the user's voice as the statement for executing music playing function and determines that the first behavior instruction corresponding to the statement for executing music playing function is executing music playing function through the first relationship table S1, the executing module 104 plays music; a piece of music from a music library of the smart robot 1 is searched for according to the user's selection, and the found music is played back through the voice output unit 121.

In another embodiment, the user's voice in the first relationship table S1 can be a statement for inquiring as to weather conditions, and the first behavior instruction corresponding to such statement is discovering the weather condition. When the processing module 103 identifies the user's voice as the statement for weather inquiry and determines the first behavior instruction as corresponding to the statement for weather inquiry through the first relationship table S1, the executing module 104 controls the smart robot 1 to connect to the network 5 and search for weather conditions according to the first behavior instruction. The searched weather conditions are described and output through the voice output unit 121.

In another embodiment, the user's voice in the first relationship table S1 can be a statement requiring video playing function, and the first behavior instruction corresponding to such statement is playing video. When the processing module 103 identifies the user's voice as the statement requiring video playing function and determines that the first behavior instruction corresponding to such statement is playing video, through the first relationship table S1, the executing module 104 executes video playing function of the smart robot 1. A video may be searched for from the network 5 according to the user's selection, and the found video output through the display unit 123.

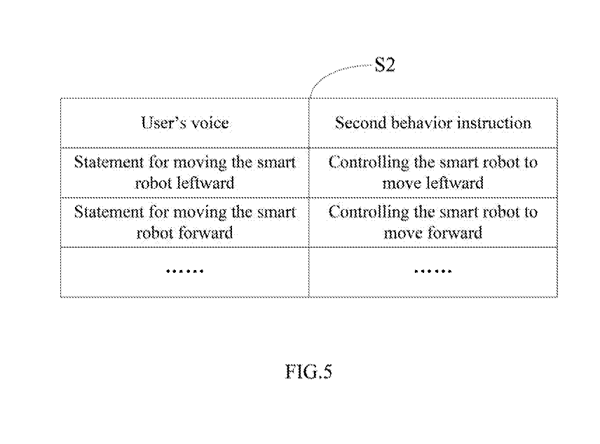

The multi-level relationship table includes a second relationship table S2. FIG. 5 illustrates a schematic diagram of one embodiment of the second relationship table S2. The second relationship table S2 includes a number of the user's voices and a number of second behavior instructions, and defines a relationship between the number of the user's voices and the number of second behavior instructions. The user's voice can be a statement requiring movement of the smart robot 1. The second behavior instruction is an instruction for controlling the smart robot 1 to move corresponding to the user's voice. For example, the user's voice in the second relationship table S2 can be a statement for moving the smart robot 1 leftward, and the second behavior instruction corresponding to such statement is controlling the smart robot 1 to move leftward. When the processing module 103 identifies the user's voice as the statement for moving the smart robot 1 leftward and determines through the second relationship table S2 the second behavior instruction corresponding to such statement as controlling the smart robot 1 to move leftward, the executing module 104 controls the movement assembly 1221 to drive the smart robot 1 to move leftward and may optionally control the light emitting assembly 1222 to emit light. In at least one embodiment, when the processing module 103 identifies the user's voice as the statement for moving the smart robot 1 leftward, the executing module 104 may optionally open the two eyes of the smart robot 1 and the mouth of the smart robot 1, and can drive the driving wheel of the smart robot 1 to move leftward.

In at least one embodiment, the user's voice in the second relationship table S2 can be a statement to cause forward movement of the smart robot 1, and the second behavior instruction corresponding to such statement is controlling the smart robot 1 to move forward. When the processing module 103 identifies the user's voice as the statement for moving the smart robot 1 forward and determines the second behavior instruction corresponding to such statement is controlling the smart robot 1 to move forward, through the second relationship table S2, the executing module 104 drives the driving wheel of the smart robot 1 to move forward and may optionally open the eyes of the smart robot 1 and the mouth of the smart robot 1.

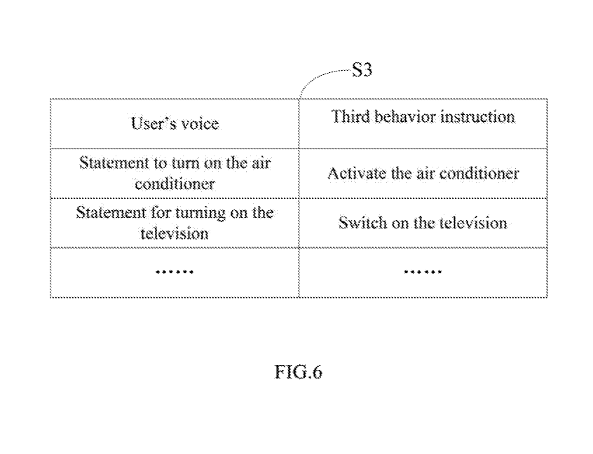

In at least one embodiment, the multi-level relationship table includes a third relationship table S3. FIG. 6 illustrates a schematic diagram of one embodiment of the third relationship table S3. The third relationship table S3 includes a number of the user's voices and a number of third behavior instructions, and defines a relationship between the number of the user's voices and the number of third behavior instructions. The user's voice can be a statement for controlling one of the second external devices 3. The third behavior instruction is an instruction for controlling a second external device 3. In one embodiment, the second external device 3 can be an air conditioner. The user's voice in the third relationship table S3 can be a statement to turn on the air conditioner, and the third behavior instruction corresponding to such statement is activating the air conditioner. When the processing module 103 identifies the user's voice as the statement for turning on the air conditioner and determines the corresponding third behavior instruction as turning one the air conditioner, through the third relationship table S3, the executing module 104 controls the infrared remote controller 16 to activate the air conditioner. The executing module 104 can further change working mode of the air conditioner, and can adjust the temperature and other variable functions of the air conditioner, according to the user's voice.

In at least one embodiment, the second external device 3 can be a television. The user's voice in the third relationship table S3 can be a statement to turn on the television, and the third behavior instruction corresponding to such statement is switching on the television. When the processing module 103 identifies the user's voice as the statement for turning on the television and determines that the third behavior instruction corresponding to such statement is switching on the television, through the third relationship table S3, the executing module 104 controls the infrared remote controller 16 accordingly. The executing module 104 can further change television channel, and adjusts the volume of the television.

In at least one embodiment, the receiving module 101 receives the smells around the smart robot 1 detected by the detection unit 113. The processing module 103 analyzes the smells, and controls the voice output unit 121 to output a message when an analyzed smell is harmful. In at least one embodiment, the multi-level relationship table includes a fourth relationship (not shown). The fourth relationship table includes a number of detectable smells and a number of hazard levels, and defines a relationship between the number of smells and the number of hazard levels. The processing module 103 determines whether a smell received by the receiving module 101 is harmful, and controls the voice output unit 121 to output the warning message when the smell is harmful.

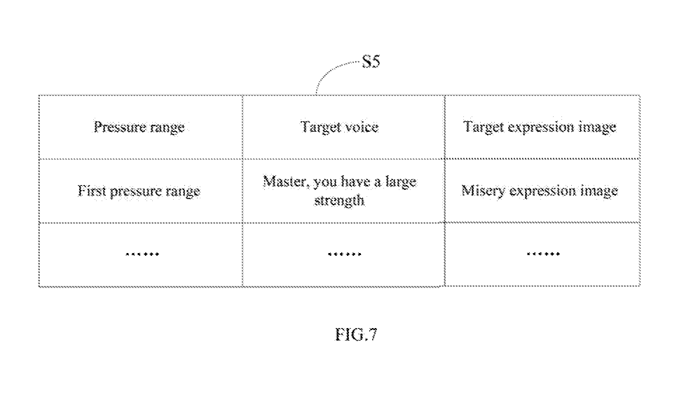

In at least one embodiment, the receiving module 101 receives the user's physical contact as pressure on the smart robot 1, detected by the pressure detection unit 18. The processing module 103 determines a target voice and an expression image according to the user's pressure on the smart robot 1, and controls the voice output unit 121 to output the target voice and controls the display unit 123 to display the expression image. In at least one embodiment, the multi-level relationship table includes a fifth relationship table S5. FIG. 7 illustrates a schematic diagram of one embodiment of the fifth relationship table S5. The fifth relationship table S5 includes a number of pressure ranges, a number of target voices, and a number of target expression images, and defines a relationship there between. The processing module 103 determines the target voice and the target expression image according to the pressure on the smart robot 1 and the fifth relationship table S5. In fifth relationship table S5, the target voice corresponding to the first pressure range is “master, you have great strength”, and the target expression image according to the first pressure range is “misery”. When the pressure on the smart robot 1 is in the first pressure range, the processing module 103 determines that the target voice corresponding to the pressure is “master, you have great strength”, that the target expression image corresponding to such pressure is “misery”, controls the voice output unit 121 to state “master, you have great strength”, and controls the display unit 123 to display the “misery” image.

In at least one embodiment, the receiving module 101 receives a verbal command to recharge, detected by the voice collection unit 112. The executing module 104 controls the movement assembly 1221 to drive the smart robot 1 to move to a contact type charging device (not shown) and to recharge according to the instruction. In at least one embodiment, the contact type charging device has a WIFI directional antenna. The WIFI directional antenna is able to emit a directional WIFI signal source. The executing module 104 determines a target direction according to the directional WIFI signal source, controls the driving wheel of the movement assembly 1221 to move to such charging device along the target direction, and controls the smart robot 1 to make contact with the contact type charging device. In at least one embodiment, the receiving module 101 further receives warning of a barrier in the target direction is detected by the ultrasonic sensor 19. The executing module 104 controls the movement assembly 1221 to drive the smart robot 1 to avoid the barrier when moving to the contact type charging device.

In at least one embodiment, the control system 100 further includes a sending module 105. The sending module 105 is used to send an image captured by the camera 111 to the first external device 2 through the communication unit 14. In another embodiment, the sending module 105 further sends the image to a server of the network 5 for storage. The first external device 2 can acquire the image by accessing the server.

In at least one embodiment, the receiving module 101 receives a control signal sent by the first external device 2 through the communication unit 14. The processing module 104 controls the infrared remote controller 16 to operate the second external device 3 according to the control signal. In at least one embodiment, the control signal includes an object to be controlled and a control operation corresponding to the controlled object. In at least one embodiment, the object to be controlled includes, but is not limited to, air conditioner, TV, light, and refrigerator. The control operation includes, but is not limited to, turning on/off, but may include any functions associated with the controlled object. In at least one embodiment, the receiving module 101 receives the control signal sent by the first external device 2 through the communication unit 14, controls the infrared remote controller 16 to send the control command to the object to be controlled, and controls the object according to the control operation included in the control signal.

In at least one embodiment, the receiving module 101 receives a text sent by the first external device 2 through the communication unit 14. The processing module 103 changes the text into a voice output. The executing module 104 controls the voice output unit 121 to output such text message verbally.

The embodiments shown and described above are only s. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including, the full extent established by the broad general meaning of the terms used in the claims.

What is claimed is:

1. A smart robot with communication capabilities comprising:
a camera;
a voice collection unit configured to collect use's voice;
a processor coupled with the camera and the voice collection unit;
a non-transitory storage medium coupled to the processor and configured to store a plurality of instructions, the instructions may cause the processor to do one or more of the following:
receive the user's voice through the voice collection unit;
identify the user's face image captured by the camera;
compare the identified face image with a preset face image;
identify the user's voice when the face image matches with the preset face image;
determine a behavior instruction according to the user's voice; and
execute the behavior instruction.

2. The smart robot as recited in claim 1, wherein the plurality of instructions is further configured to cause the processor to do one or more of the following:
identify user's voice and determine a first behavior instruction corresponding to the identified the user's voice through looking up a first relationship table, wherein the first relationship table comprises a plurality of the user's voices and a plurality of first behavior instructions, and defines a relationship between the plurality of the user's voices and the plurality of first behavior instructions, the user's voice can be a statement to cause execution of one of functions of the smart robot, the first behavior instruction is a function execution instruction that executes the function of the smart robot.

3. The smart robot as recited in claim 2, wherein the user's voice can be a statement requiring execution of music playing function, the first behavior instruction corresponding to the statement requiring execution of music playing function is to execute music playing function, the plurality of instructions is further configured to cause the processor to do one or more of the following:
when determining the first behavior instruction corresponding to the statement requiring execution of music playing function is executing music playing function,
execute music playing function of the smart robot;
search a music from a music library of the smart robot according to the user's selection; and
play the searched music through a voice output unit of the smart robot.

4. The smart robot as recited in claim 1, wherein the plurality of instructions is further configured to cause the processor to do one or more of the following:
identify the user's voice and determine a second behavior instruction corresponding to the identified the user's voice through looking up a second relationship table, wherein the second relationship table comprises a plurality of the user's voices and a plurality of second behavior instructions, and defines a relationship between the plurality of the user's voices and the plurality of second behavior instructions, the user's voice can be a statement requiring movement of the smart robot, the second behavior instruction is an instruction for controlling the smart robot to move.

5. The smart robot as recited in claim 4, wherein the user's voice can be a statement for moving the smart robot leftward, the second behavior instruction corresponding to the statement for moving the smart robot leftward is controlling the smart robot to move leftward, the plurality of instructions is further configured to cause the processor to do one or more of the following:
when determining the second behavior instruction corresponding to the user's voice is controlling the smart robot to turn around,
control a movement assembly of the smart robot to turn around the smart robot to turn.

6. The smart robot as recited in claim 1, wherein the plurality of instructions is further configured to cause the processor to do one or more of the following:
identify the user's voice and determine a third behavior instruction corresponding to the identified user's voice through looking up a third relationship table, wherein the third relationship table comprises a plurality of the user's voices and a plurality of third behavior instructions, and defines a relationship between the plurality of the user's voices and the plurality of third behavior instructions, the user's voice can be a statement for controlling a second external device, the third behavior instruction is an instruction for controlling the second external device.

7. The smart robot as recited in claim 6, wherein the second external device can be an air conditioner, the plurality of instructions is further configured to cause the processor to:
when determining the third behavior instruction corresponding to the user's voice is controlling the air conditioner through the third relationship table, does one or more of the following:
activate the air conditioner;
change working mode of the air conditioner; or
adjust the temperature of the air conditioner according to the user's voice.

8. The smart robot as recited in claim 1, wherein the smart robot further comprises a pressure detection unit and a display unit, the plurality of instructions is further configured to cause the processor to do one or more of the following:
receive the user's pressure detected by the pressure detection unit;
determine a target voice and an expression image according to the user's pressure; and
control a voice output unit of the smart robot to output the target voice and control the display unit to display the expression image.

9. The smart robot as recited in claim 1, wherein the plurality of instructions is further configured to cause the processor to do one or more of the following:
receive a verbal command to recharge the smart robot by the voice collection unit;
controls a movement assembly of the smart robot to drive the smart robot to move to a contact type charging pile to charge according to the verbal command.

10. The smart robot as recited in claim 3, wherein the plurality of instructions is further configured to cause the processor to do one or more of the following:
receive a text;
change the text into a voice corresponding to the; and
control the voice output unit to output the voice.
